(19) United States
(12) Patent Application Publication
(10) Pub. No.: US 2025/0235987 A1
(43) Pub. Date: Jul. 24, 2025

(54) FASTENING TOOL WITH CYLINDRICAL BODY AND OPEN SLOT FOR RATCHET

(71) Applicant: Ángel D. De Jesús-Wonderwood, Yabucoa, PR (US)

(72) Inventor: Ángel D. De Jesús-Wonderwood, Yabucoa, PR (US)

(21) Appl. No.: 18/416,562

(22) Filed: Jan. 18, 2024

(51) Int. Cl. B25B 13/06; B25B 23/00

(52) U.S. Cl. CPC B25B 13/065; B25B 23/0021

(57) ABSTRACT

A socket assembly for capturing a fastener, the socket assembly including a socket and a cylindrical sleeve. The socket includes a cylindrical body having a cylindrical wall, a cylindrical wall outer surface and a socket upper surface disposed on one end cylindrical body. The socket includes a socket open end having an edge and at least one internal face along the socket open end edge for engaging the fastener. The socket includes an access slot disposed along the cylindrical wall and a flange extending outwardly from the edge of the socket open end. The socket assembly includes a sleeve slot disposed on the cylindrical sleeve. The cylindrical sleeve is rotatable about the socket cylindrical outer surface between a first position wherein the sleeve slot is aligned with the access slot to a second position wherein the access slot is covered by a portion of the cylindrical sleeve.

### BACKGROUND OF THE INVENTION

### 1) Field of the Invention

The invention relates in general to the field of socket fastening tools for a ratchet, and more particularly, to a socket type fastening tool with a cylindrical body and an open slot.

### 2) Description of Related Art

The field of mechanical tools has seen numerous advancements over the years. One area that has been of particular interest is the development of fastening tools. These tools are essential for a variety of tasks, from assembling furniture to repairing machinery. Fastening tools come in a variety of shapes and sizes, each designed to perform a specific function. However, there are certain challenges associated with the use of these tools. For instance, some tools may not provide the necessary grip, making it difficult to fasten or unfasten screws or bolts. Additionally, some tools may not be suitable for use in tight spaces, limiting their utility. Therefore, there is a continuous quest for improvements in the design and functionality of fastening tools.

These and other objects, features, and advantages of the present invention will become more readily apparent from the attached drawings and the detailed description of the preferred embodiments, which follow.

### SUMMARY OF THE INVENTION

Bearing in mind the problems and deficiencies of the prior art, it is therefore an object of the present invention to provide a fastening tool designed for fastening operations. The tool features a socket configuration and has a body structure with a cylindrical shape that provides a structural form to the tool. The tool also includes a slot that is open and designed to accommodate a component. The tool is designed for use in various applications including industrial, automotive repair and maintenance, construction and assembly operations, home repair and maintenance, mechanical and engineering, manufacturing and production, aerospace and aviation maintenance and repair, marine repair and maintenance, electrical and electronic repair and maintenance, plumbing repair and maintenance, heavy machinery repair and maintenance, railway repair and maintenance, mining operations and maintenance, oil and gas operations and maintenance, and agricultural machinery repair and maintenance.

Still other objects and advantages of the invention will in part be obvious and will in part be apparent from the specification.

The above and other objects, which will be apparent to those skilled in the art, are achieved in the present invention which is directed to a socket assembly for capturing a fastener, the socket assembly including a socket and a cylindrical sleeve. The socket includes a cylindrical body having a cylindrical wall and an axial length. The cylindrical wall extends the axial length of the cylindrical body. The socket includes a cylindrical wall outer surface and a socket upper surface disposed on one end cylindrical body. The socket includes a socket open end opposite the socket upper surface. The socket open end has an edge and at least one internal face along the socket open end edge. The at least one internal face is for engaging the fastener. The socket includes an access slot disposed along the cylindrical wall extending the axial length of the cylindrical body and a flange extending outwardly from the edge of the socket open end. The socket assembly cylindrical sleeve has a sleeve axial length and is rotatable about the socket cylindrical outer surface wherein the flange secures the cylindrical sleeve axially on the cylindrical body. The socket assembly includes a sleeve slot disposed on the cylindrical sleeve along the sleeve axial length. The socket assembly includes an attachment opening disposed on the socket upper surface for insertion of a socket extension wherein the attachment opening is elongated and a socket extension is slidable in the attachment opening. The cylindrical sleeve is rotatable between a first position wherein the sleeve slot is aligned with the access slot to a second position wherein the access slot is covered by a portion of the cylindrical sleeve. When the cylindrical sleeve is in the second position, the cylindrical sleeve provides support for the socket when a force is applied to the socket which urges expansion of the socket open end. The socket assembly may include a plurality of ball bearings disposed between the cylindrical sleeve and the socket wall outer surface. The socket assembly includes a spring disposed between each ball bearing and the socket wall outer surface. The socket open end may be hexagonally shaped wherein two of the hexagonal faces are absent to accommodate a male threaded fastener. The socket open end may alternately be shaped for engagement with a specific fastener. The attachment opening may intersect the access slot whereby a male threaded fastener for engagement of the fastener passes through the sleeve slot and the access slot when the sleeve slot is in the first position and is captured in a cavity of the socket when the sleeve slot is in the second position. A male threaded fastener for engagement of the fastener may be passed through the sleeve slot and the socket slot when the sleeve slot is in the first position and is captured in a cavity of the socket when the sleeve slot is in the second position. The socket may include an auxiliary attachment opening disposed on the socket upper surface, the auxiliary attachment opening spaced from the attachment opening for insertion of the socket extension if the attachment opening is inaccessible.

Another aspect of the present invention is directed to a method for using the socket assembly for removal of a fastener engaged with an elongated male threaded fastener. The method includes engaging a socket extension in the attachment opening, ensuring the socket extension is positioned in the extension slot toward the socket cylindrical wall, ensuring the cylindrical sleeve is in the first position and placing the socket adjacent to the elongated male threaded fastener. The method includes placing the socket around the elongated male threaded fastener wherein the elongated male threaded fastener extends through the socket along a socket central axis. The method includes moving the cylindrical sleeve to the second position, rotating the socket extension to loosen or tighten the fastener and continuing to rotate the socket extension until the fastener is at a desired position.

Another aspect of the present invention is directed to a socket assembly for capturing a fastener. The socket assembly includes a cylindrical socket having a length, a cylindrical wall, a socket top disposed on one end of the cylindrical wall and a cavity within the cylindrical wall. The socket assembly include an access slot extending the length of the cylindrical socket and a sleeve rotatable about the cylindrical wall wherein the sleeve is rotatable between a first position wherein the access slot is open for access of a threaded fastener to a second position wherein the access slot is covered by a portion of the sleeve. The socket assembly includes an attachment opening disposed on the socket top wherein the attachment opening intersecting the access slot to allow a threaded fastener to extend through the cylindrical socket cavity when a socket attachment is secured to the attachment opening.

The socket assembly may include a plurality of ball bearings disposed between the cylindrical sleeve and the cylindrical wall and may further include a spring disposed between each ball bearing and the cylindrical sleeve. The socket open end may be hexagonally shaped or shaped for engagement with a specific fastener. The socket open end may include four adjacent faces of a hexagonally shaped polyhedron wherein the remaining two hexagonal faces of the hexagonal polyhedron are absent to accommodate a male threaded fastener. The socket open end may alternately be shaped for engagement with a specific fastener.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is a bottom plan view of the socket assembly with the cylindrical sleeve in the first position, according to the present invention;

FIG. 2 is a bottom plan view of the socket assembly with the cylindrical sleeve in the second position;

FIG. 3 is a cross sectional front elevational view along cut line 3-3 of FIG. 2;

FIG. 4 is a top plan view of the socket assembly with the cylindrical sleeve in the first position;

FIG. 5 is a top plan view of the socket assembly with the cylindrical sleeve in the second position;

FIG. 6 is a top plan view of another embodiment of the socket assembly with the cylindrical sleeve in the first position;

FIG. 7 is a top plan view of another embodiment of the socket assembly with the cylindrical sleeve in the second position;

FIG. 8 is an enlarged top plan view of the bearing assembly shown in FIG. 7;

FIG. 9 is a top plan view of another embodiment of the socket assembly having an auxiliary attachment opening;

FIG. 10 is a front elevational view of a socket assembly kit having a socket assembly, ratchet handle and extension; and

FIG. 11 is a flowchart showing a method for using the socket assembly, according to the present invention.

Included reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

As this invention is susceptible to embodiments of many different forms, it is intended that the present disclosure be considered as an example of the principles of the invention and not intended to limit the invention to the specific embodiments shown and described.

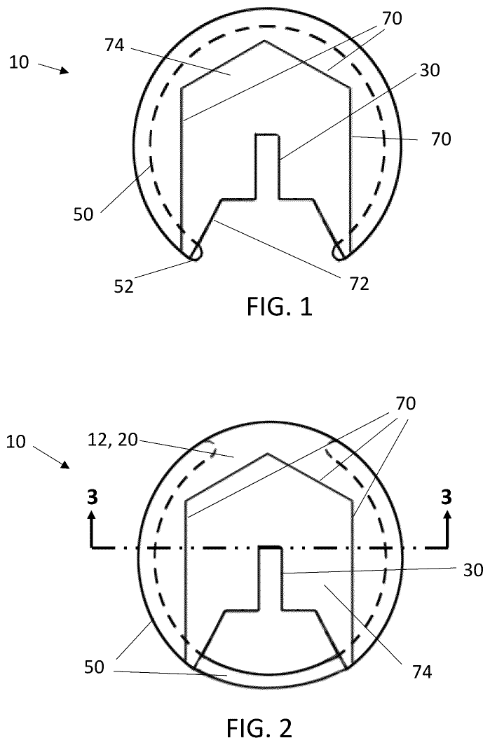

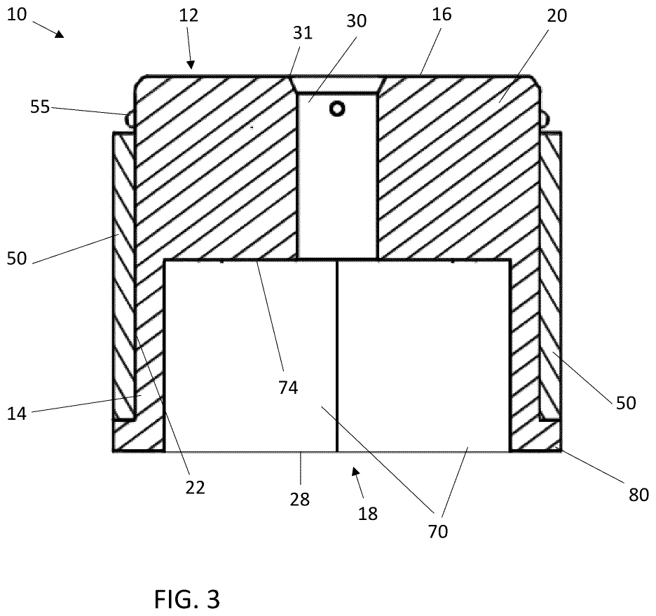

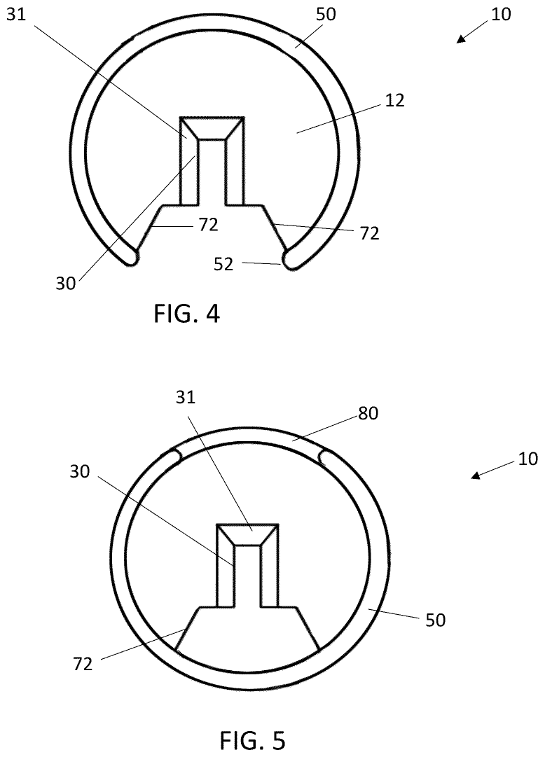

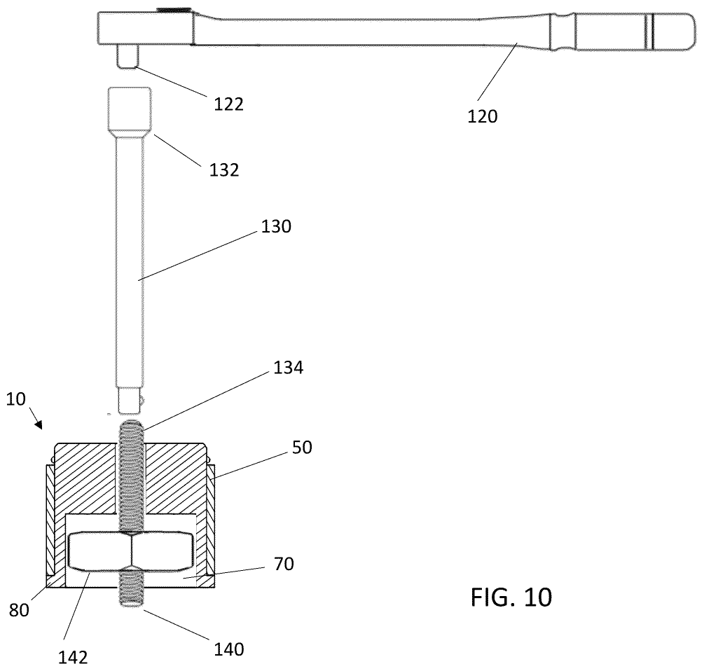

Referring now to the drawings FIGS. 1-11, and more particularly to FIGS. 1-5, there is shown a socket assembly 10 for capturing a fastener 142 (FIG. 10), the socket assembly 10 including a socket 12 and a cylindrical sleeve 50. The socket 12 includes a cylindrical body 20 having a cylindrical wall 14 and an axial length. The cylindrical wall 14 extends a portion of the axial length of the cylindrical body 20. The socket 12 includes a cylindrical wall outer surface. The socket 12 includes a cylindrical wall outer surface and a socket upper surface 16 disposed on one end cylindrical body. The socket 12 includes a socket open end 18 opposite the socket upper surface 16. The socket open end 18 has an edge 28 along the socket cylindrical rim and at least one internal face 70 along the socket open end edge 28. The at least one internal face 70 is for engaging the fastener 142. The socket includes an access slot disposed along the cylindrical wall and the cylindrical body, the access slot extending the axial length of the cylindrical body. The socket 12 includes a flange 80 extending outwardly from the edge of the socket open end edge 28. The socket assembly cylindrical sleeve 50 has a sleeve axial length and is rotatable about the socket cylindrical outer surface 22 wherein the flange 80 secures the cylindrical sleeve 50 axially on the cylindrical body 20. The socket assembly 10 includes a sleeve slot 52 disposed on the cylindrical sleeve 50 along the sleeve axial length. The socket assembly 10 includes an attachment opening 30 disposed on the socket upper surface for insertion of a socket extension 130 (FIG. 10) wherein the attachment opening 30 is elongated and a socket extension male end 134 is slidable in the attachment opening 30. The attachment opening 30 includes a bevel 31 (FIG. 3-5) along the top of the attachment opening 30 and a dimple for securing the socket extension in the attachment opening 30. The cylindrical sleeve 50 is rotatable between a first position wherein the sleeve slot 52 is aligned with the access slot 72 to a second position wherein the access slot 72 is covered by a portion of the cylindrical sleeve 50. When the cylindrical sleeve 50 is in the second position, the cylindrical sleeve 50 provides support for the socket when a force is applied to the socket which urges expansion of the socket open end 18. The socket open end 18 may be hexagonally shaped wherein two of the hexagonal faces are absent to accommodate a male threaded fastener. The socket open end 18 may alternately be shaped for engagement with a specific fastener. The socket open end 18 may include four adjacent faces of a hexagonally shaped polyhedron wherein the remaining two hexagonal faces of the hexagonal polyhedron are absent to accommodate a male threaded fastener. The socket open end 18 may alternately be shaped for engagement with a specific fastener. The attachment opening 30 may intersect the access slot whereby a male threaded fastener 140 (FIG. 10) for engagement of the fastener 142 passes through the sleeve slot 52 and the access slot 72 when the sleeve slot 52 is in the first position and the male threaded fastener 140 is captured in a cavity of the socket when the sleeve slot 52 is in the second position. A plurality of socket protrusions 55 extend outwardly from the socket cylindrical wall 14, the socket protrusions 55 for preventing upward slippage of the cylindrical sleeve 50. As shown in FIG. 10, the male threaded fastener 140 extends through the attachment opening 30 and since the attachment opening 30 is elongated, the attachment opening 30 may accommodated both the male threaded fastener 140 and the socket extension 130. The socket assembly socket open end includes four surfaces positioned as four adjacent side faces of a hexagonally shaped polyhedron having six side faces for engaging the fastener and an access slot juxtaposed with the other two side faces of the hexagonally shaped polyhedron.

In another embodiment of the present invention shown in FIG. 9, a socket assembly 210 may include an auxiliary attachment opening 232 disposed on the socket upper surface, the auxiliary attachment opening 232 spaced from the attachment opening 230 for insertion of the socket extension 130 shown in FIG. 10 if the attachment opening 230 is inaccessible. The socket assembly 210 includes a cylindrical sleeve 250 slidable about the socket and socket flange 280. FIG. 9 shows the socket assembly 210 in the second or closed position wherein the access slot 272 is covered.

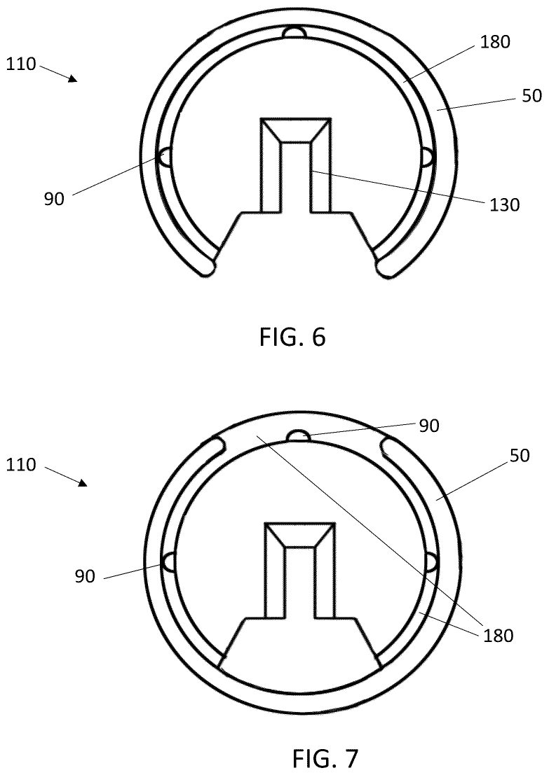

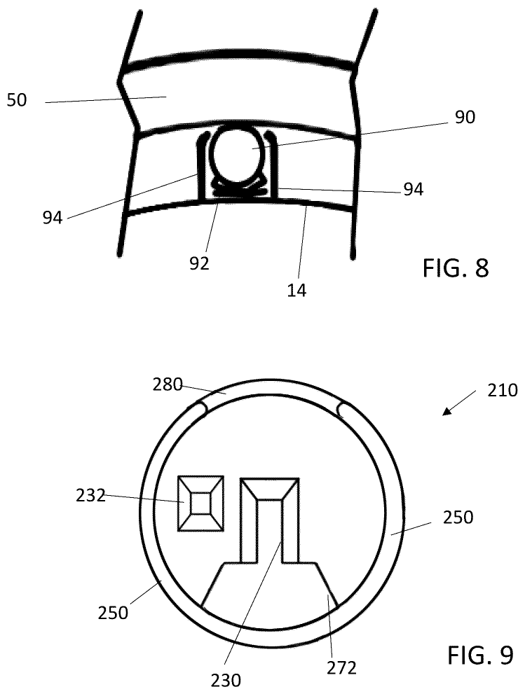

Another embodiment of the invention is a system 110 shown in FIG. 6 with the cylindrical sleeve in the first position, the open position. The system 110 is shown in FIG. 7 with the cylindrical sleeve in the second position, the closed position. The socket assembly 10 may include a plurality of ball bearings 90 shown enlarged in FIG. 8. The ball bearings 90 are disposed between the cylindrical sleeve 50 and the socket wall outer surface 22. The socket assembly 110 includes a spring 92 disposed between each ball bearing 90 and the socket wall outer surface 22.

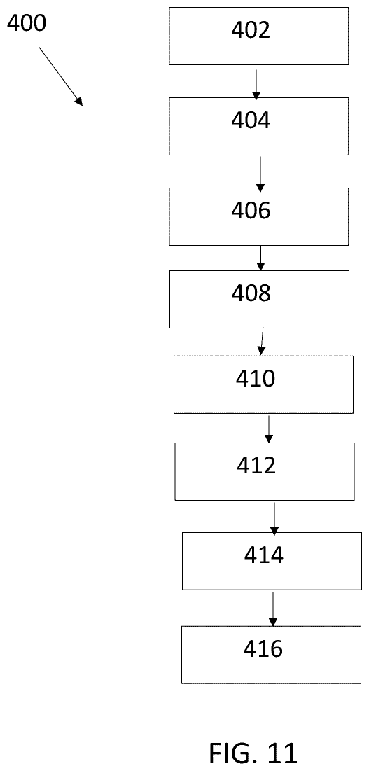

Another aspect of the present invention is directed to a method 400 for using the socket assembly for removal of the fastener engaged with an elongated male threaded fastener as shown in FIG. 11. The method includes engaging 402 a socket extension in the attachment opening, ensuring 404 the socket extension is positioned in the extension slot toward the socket cylindrical wall, ensuring 406 the cylindrical sleeve is in the first position and placing 408 the socket adjacent to the elongated male threaded fastener. The method includes placing 410 the socket around the elongated male threaded fastener wherein the elongated male threaded fastener extends through the socket along a socket central axis. The method includes moving 412 the cylindrical sleeve to the second position, rotating 414 the socket extension to loosen or tighten the fastener and continuing 416 to rotate the socket extension until the fastener is at a desired position.

Another aspect of the present invention is directed to a socket assembly 10 for capturing a fastener as shown in FIGS. 1-5. The socket assembly 10 includes a cylindrical socket 12 having a length, a cylindrical wall 14, a socket upper surface 16 disposed on one end of the cylindrical wall 14 and a cavity 18 within the cylindrical wall 14. The socket assembly 10 includes an access slot 72 extending the length of the cylindrical socket 12 and a cylindrical sleeve 50 rotatable about the cylindrical wall 14 wherein the cylindrical sleeve 50 is rotatable between a first position wherein the access slot 72 is open for access of a threaded fastener 140 to a second position wherein the access slot 72 is covered by a portion of the cylindrical sleeve 50. The socket assembly 10 includes an attachment opening 30 disposed on the socket upper surface 16 wherein the attachment opening 30 intersects the access slot 72 to allow a threaded fastener 140 to extend through the cylindrical socket cavity 18 when a socket attachment or extension 130 is secured to the attachment opening 30. The attachment opening 30 includes a bevel 31 (FIGS. 3-5) along the top of the attachment opening 30 and a dimple for securing the socket extension in the attachment opening 30.

The socket assembly 10 may include a plurality of ball bearings 90 disposed between the cylindrical sleeve 50 and the cylindrical wall 14 and may further include a spring 92 disposed between each ball bearing and the cylindrical wall 14 or socket outer surface 22. The socket open end 18 may include four adjacent faces of a hexagonally shaped polyhedron wherein the remaining two hexagonal faces of the hexagonal polyhedron are absent to accommodate a male threaded fastener. The socket open end 18 may alternately be shaped for engagement with a specific fastener. In other words, the socket open end 18 may be hexagonally shaped wherein two of the hexagonal faces are absent to accommodate a male threaded fastener, whereby the socket may engage the elongated male threaded fastener from the top where components near the elongated male threaded fastener prevent access from the side or whereby the socket may engage the elongated male threaded fastener from the side where components near the elongated male threaded fastener prevent access from the top. The socket open end 18 may alternately be shaped for engagement with a specific fastener.

The socket open end includes four surfaces 72 positioned as four adjacent side faces of a hexagonally shaped polyhedron having six side faces for engaging the fastener and an access slot juxtaposed with the other two side faces of the hexagonally shaped polyhedron.

In various example embodiments, the tool is designed for use in diverse industrial applications, automotive repair and maintenance, construction and assembly operations, home repair and maintenance, mechanical and engineering applications, manufacturing and production operations, aerospace and aviation maintenance and repair, marine repair and maintenance, electrical and electronic repair and maintenance, plumbing repair and maintenance, heavy machinery repair and maintenance, railway repair and maintenance, mining operations and maintenance, oil and gas operations and maintenance, and agricultural machinery repair and maintenance. These various designs contribute to the overall versatility of the tool.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A socket assembly for capturing a fastener, the socket assembly comprising:
a socket having:
a cylindrical body having a cylindrical wall and an axial length, the cylindrical wall extending a portion of the axial length of the cylindrical body and a cylindrical wall outer surface;
a socket upper surface disposed on one end of the cylindrical body;
a socket open end opposite the socket upper surface, the socket open end having an edge and at least one internal face along the socket open end edge, the at least one internal face for engaging the fastener;
an access slot disposed along the cylindrical wall and the cylindrical body, the access slot extending the axial length of the cylindrical body; and
a flange extending outwardly from the edge of the socket open end;
a cylindrical sleeve having a sleeve axial length, the cylindrical sleeve rotatable about the socket cylindrical outer surface wherein the flange secures the cylindrical sleeve axially on the cylindrical body;
a sleeve slot disposed on the cylindrical sleeve along the sleeve axial length;
an attachment opening disposed on the socket upper surface for insertion of a socket extension wherein the attachment opening is elongated and a socket extension is slidable in the attachment opening;
wherein the cylindrical sleeve is rotatable between a first position wherein the sleeve slot is aligned with the access slot to a second position wherein the access slot is covered by a portion of the cylindrical sleeve; and
wherein when the cylindrical sleeve is in the second position, the cylindrical sleeve provides support for the socket when a force is applied to the socket which urges expansion of the socket open end.

2. The socket assembly according to claim 1 including a plurality of ball bearings disposed between the cylindrical sleeve and the socket wall outer surface.

3. The socket assembly according to claim 2 including a spring disposed between each ball bearing and the socket wall outer surface.

4. The socket assembly according to claim 1, wherein the socket open end includes four surfaces positioned as four adjacent side faces of a hexagonally shaped polyhedron having six side faces for engaging the fastener and an access slot juxtaposed with the other two side faces of the hexagonally shaped polyhedron.

5. The socket assembly according to claim 1, wherein the socket open end is shaped for engagement with the fastener.

6. The socket assembly according to claim 1 wherein the attachment opening intersects the access slot whereby a male threaded fastener for engagement of the fastener passes through the sleeve slot and the access slot when the sleeve slot is in the first position and is captured in a cavity of the socket when the sleeve slot is in the second position.

7. The socket assembly according to claim 1 wherein a male threaded fastener for engagement of the fastener is passed through the sleeve slot and the socket slot when the sleeve slot is in the first position and is captured in a cavity of the socket when the sleeve slot is in the second position.

8. The socket assembly according to claim 1 including an auxiliary attachment opening disposed on the socket upper surface, the auxiliary attachment opening spaced from the attachment opening for insertion of the socket extension if the attachment opening is inaccessible.

9. The socket assembly according to claim 1 including a plurality of socket protrusions extending from the socket cylindrical wall, the socket protrusions for preventing upward slippage of the cylindrical sleeve.

10. A method for using the socket assembly according to claim 1 for removal of the fastener engaged with an elongated male threaded fastener, the method comprising:
engaging a socket extension in the attachment opening;
ensuring the socket extension is positioned in the extension slot toward the socket cylindrical wall;
ensuring the cylindrical sleeve is in the first position;
placing the socket adjacent to the elongated male threaded fastener;
placing the socket around the elongated male threaded fastener wherein the elongated male threaded fastener extends through the socket along a socket central axis;
moving the cylindrical sleeve to the second position;
rotating the socket extension to loosen or tighten the fastener;
continuing to rotate the socket extension until the fastener is at a desired position.

11. The method according to claim 10 including a plurality of ball bearings disposed between the cylindrical sleeve and the socket wall outer surface.

12. The method according to claim 11 including a spring disposed between each ball bearing and the socket wall outer surface.

13. The method according to claim 10, wherein an interior portion of the cylindrical wall includes four surfaces positioned as four adjacent side faces of a hexagonally shaped polyhedron having six side faces for engaging the fastener and an access slot juxtaposed with the other two side faces of the hexagonally shaped polyhedron.

14. The method according to claim 10, wherein an interior portion of the cylindrical wall along the socket open end is shaped for engagement with the fastener.

15. A socket assembly for capturing a fastener, the socket assembly comprising:
a cylindrical socket having a length, a cylindrical wall, a socket top disposed on one end of the cylindrical wall and a cavity within the cylindrical wall;
an access slot extending the length of the cylindrical socket;
a sleeve rotatable about the cylindrical wall wherein the sleeve is rotatable between a first position wherein the access slot is open for access of the fastener to a second position wherein the access slot is covered by a portion of the sleeve; and
an attachment opening disposed on the socket top wherein the attachment opening intersecting the access slot to allow the fastener to extend through the cavity when a socket attachment is secured to the attachment opening.

16. The socket assembly according to claim 15 including a plurality of ball bearings disposed between the cylindrical sleeve and the cylindrical wall.

17. The socket assembly according to claim 16 including a spring disposed between each ball bearing and the socket wall outer surface.

18. The socket assembly according to claim 15, wherein the socket open end includes four surfaces positioned as four adjacent side faces of a hexagonally shaped polyhedron having six side faces for engaging the fastener and an access slot juxtaposed with the other two side faces of the hexagonally shaped polyhedron.

19. The socket assembly according to claim 15, the socket open end is shaped for engagement with the fastener.

20. The socket assembly according to claim 15 including an auxiliary attachment opening disposed on the socket upper surface, the auxiliary attachment opening spaced from the attachment opening for insertion of the socket extension if the attachment opening is inaccessible.
